(19) United States
(12) Patent Application Publication
(10) Pub. No.: US 2014/0003201 A1
(43) Pub. Date: Jan. 2, 2014

(54) ELECTRONIC CLOCK

(71) Applicant: Seiko Clock Inc., Tokyo (JP)

(72) Inventor: Hiroyuki SATO, Tokyo (JP)

(73) Assignee: Seiko Clock Inc., Tokyo (JP)

(21) Appl. No.: 14/018,785

(22) Filed: Sep. 5, 2013

Related U.S. Application Data
(63) Continuation of application No. PCT/JP2012/054247, filed on Feb. 22, 2012.

(30) Foreign Application Priority Data
Mar. 8, 2011 (JP) 2011-050838

(51) Int. Cl. G04G 5/00

(52) U.S. Cl. CPC G04G 5/002
USPC 368/47

(57) ABSTRACT

An electronic clock includes: a drive source; a second hand wheel secured with a second hand, and rotated by receiving drive force from the drive source; a connection wheel rotated by receiving a drive force from the second hand wheel; an adjustment wheel adjusting positions of a minute hand and an hour hand, and a minute hand pipe secured with the minute hand, slidably connected with the connection wheel, and including a teeth portion to which drive force is transmitted from the adjustment wheel, and the minute hand pipe slidably rotating with respect to the connection wheel when the minute hand pipe receives the drive force from the adjustment wheel.

### CROSS-REFERENCE TO RELATED APPLICATION

This application is a continuation of and claims priority to International Patent Application No. PCT/JP2012/054247 filed on Feb. 22, 2012, which claims priority to Japanese Patent Application No. 2011-050838 filed on Mar. 8, 2011, subject matter of these patent documents is incorporated by reference herein in its entirety.

### BACKGROUND

(i) Technical Field

The present invention relates to electronic clocks.

(ii) Related Art

Japanese Unexamined Patent Application Publication No. 2002-296374 discloses a radio-controlled clock correcting time based on standard radio waves.

In general, a clock may be used in a state where hands are set forward or back with respect to the actual time in a region where the clock is used. For example, the clock may be used in a state where the hands are set forward by several minutes or in a state where the hands are set to foreign time. In this case, as for a conventional radio-controlled clock, the positions of the hands are finally corrected to match the time information included in standard radio waves. For this reason, the radio-controlled clock is not suitable in such a use manner.

A general clock except for the radio-controlled clock can be used in the above manner. However, the general clock cannot maintain a constant difference between the actual time and the time indicated by the hands, due to the error of the clock itself, as the use time passes.

### SUMMARY

It is thus object of the present invention to provide an electronic clock which can maintain a constant difference between actual time and hand-indicating time.

According to an aspect of the present invention, there is provided an electronic clock including: a drive source; a second hand wheel secured with a second hand, and rotated by receiving drive force from the drive source; a connection wheel rotated by receiving a drive force from the second hand wheel; an adjustment wheel adjusting positions of a minute hand and an hour hand; a minute hand pipe secured with the minute hand, slidably connected with the connection wheel, and including a teeth portion to which drive force is transmitted from the adjustment wheel, and the minute hand pipe slidably rotating with respect to the connection wheel when the minute hand pipe receives the drive force from the adjustment wheel; an internal clock measuring an elapsed period based on a reference signal from a reference signal source; a receiver receiving a standard radio wave including time information; and a control unit outputting a drive pulse to the drive source, and performing correction process for synchronizing output timing of the drive pulse with rising timing of a pulse signal at one-second intervals of the standard radio wave.

### BRIEF DESCRIPTION OF THE DRAWINGS

FIG. 1 is a configuration view of an analog electronic clock according to the present embodiment;

FIG. 2 is a sectional view of a movement of the electronic clock;

FIG. 3A is a front view of a minute hand wheel and a minute hand pipe, and FIG. 3B is a sectional view taken along line A-A of FIG. 3A;

FIGS. 4A and 4B are timing charts of second signals of standard radio waves and drive pulses;

FIGS. 5A and 5B are timing charts of the second signals of the standard radio waves and the drive pulses;

FIG. 6 is a flowchart of an example of correction processing of a second hand just after the power is turned on; and

FIG. 7 is a flowchart of the correction processing of the second hand after the standard radio wave is received at a second time or later.

### DETAILED DESCRIPTION

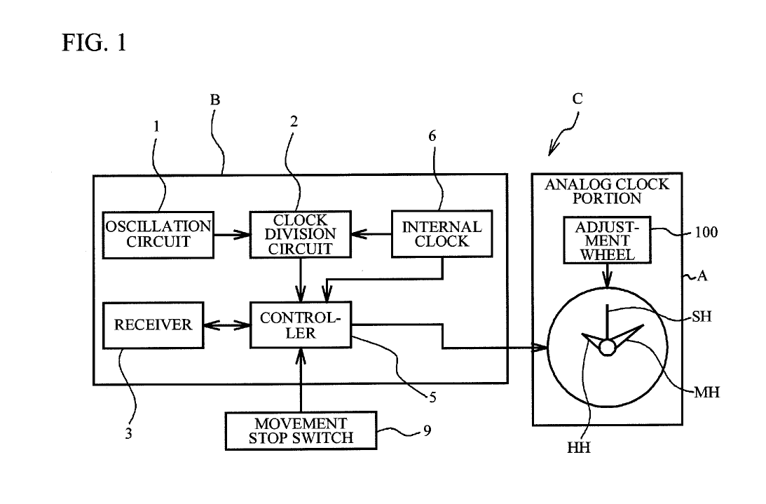

FIG. 1 is a configuration view of an analog electronic clock C according to the present embodiment. The electronic clock C has an analog clock portion A and a control circuit B. The analog clock portion A, as will be described later in detail, includes: hands indicating the time; gears driving the hands; a motor as a drive source driving the gears; and a adjustment wheel 100 adjusting positions of a minute hand and a hour hand. The hands include the hour hand HH, the minute hand MH, and a second hand SH.

The control circuit B controls the whole operation of the analog clock portion A. The control circuit B includes an oscillation circuit 1, a clock division circuit 2, a receiver 3, a controller 5, and an internal clock 6. For example, the control circuit B is a circuit where an IC and various electric parts are mounted. The oscillation circuit 1 is connected with a reference signal source, not illustrated, such as a quartz resonator. The oscillation circuit 1 causes the reference signal source to oscillate high-frequency signals, and outputs these signals to the clock division circuit 2. The internal clock 6 has an internal counter. The internal counter includes a hour counter, a minute counter, and a second counter. The internal clock 6 counts 16 Hz signals and obtains a pulse signal output from the clock division circuit 2 generating 1 Hz signals so as to count up counter values of the second counter by one second.

The controller 5 receives standard radio waves including the time information through the receiver 3 and an antenna not illustrated. The controller 5, as will be described in detail, controls positions of the second hand SH, the minute hand MH, and the hour hand HH, based on information on the second of the received standard radio wave. The standard time radio wave signal is transmitted at 1 bit per second for every minute as a single frame.

This signal includes information on the minute, the hour, and the integrated date from January 1, and this information is indicated by a pulse width of a rectangular pulse in this frame. Transmitted data includes position markers which are so-called P codes. Multiple P codes are included in a single frame, and the P codes sequentially appears only at 59 and 0 seconds. Thus, the controller 5 detects two sequential P codes in the standard radio waves to recognize a position on the minute (0 second). Specifically, the pulse width of the P cord is 200 ms. When the controller 5 detects the rectangular pulses which each has 200 ms in wide twice, the controller 5 recognizes the rising timing of the second rectangular pulse as a position on the minute (0 second). Additionally, in the present embodiment, a signal which is included in the standard radio wave and which is output every second is referred to as a second signal. The second P code signal (0 seconds signal) of a series of the P codes is referred to as a minute position signal.

The electronic clock C is provided with a movement stop switch 9. The movement stop switch 9 is provided, for example, at the back side of the clock. When the movement stop switch 9 is turned on, the controller 5 stops outputting drive pulses to a motor, as will be described later. Also, when the movement stop switch 9 is turned off, the controller 5 outputs the drive pulses to the motor to move the hands.

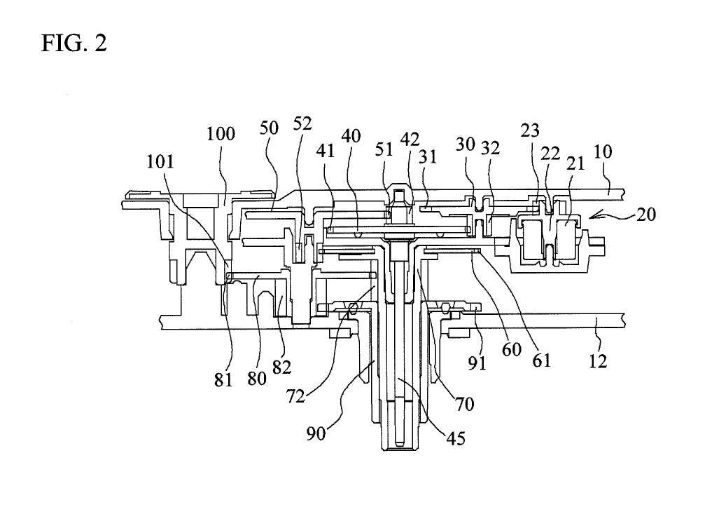

FIG. 2 is a sectional view of the movement of the electronic clock C. The movement is arranged between a back plate 10 and a front plate 12. The movement includes a motor 20 as a drive source and gears transmitting the drive force of the motor 20 to the hands. A dial plate is arranged at the front plate 12 side. The motor 20 includes: a rotor 21 rotatably supported; a rotational shaft 22 fixed in the rotor 21; and a pinion gear 23 formed at the rotational shaft 22.

The pinion gear 23 meshes with a tooth portion 31 of a gear 30. The gear 30 is formed with: the tooth portion 31; and a tooth portion 32 having a pitch diameter smaller than that of the tooth portion 31. The tooth portion 32 meshes with a tooth portion 41 of a second hand wheel 40. A shaft portion 45 is formed at the front side of the second hand wheel 40. The front end of the shaft portion 45 is attached with a second hand SH not illustrated. Also, a tooth portion 42 is formed at the back side of the second hand wheel 40. The pitch diameter of the tooth portion 42 is smaller than that of the tooth portion 41. The tooth portion 42 meshes with a tooth portion 51 of a gear 50. The gear 50 is formed with a tooth portion 52 having a pitch diameter smaller than that of the tooth portion 51. The tooth portion 52 meshes with a tooth portion 61 of a minute hand wheel 60.

A minute hand pipe 70 is slidably connected with the minute hand wheel 60. The minute hand pipe 70 has a pipe shape. The shaft portion 45 penetrates through the inside of the minute hand pipe 70. The front side of the minute hand pipe 70 is attached with a minute hand MH not illustrated. The minute hand pipe 70 is formed with a tooth portion 72. The tooth portion 72 meshes with a tooth portion 81 of a gear 80. The gear 80 is formed with a tooth portion 82 having a pitch diameter smaller than that of the tooth portion 81. The tooth portion 82 meshes with a tooth portion 91 of a hour hand wheel 90. The front end of the hour hand wheel 90 is attached with a hour hand HH not illustrated. Thus, the drive force of the motor 20 is decelerated and transmitted to the second hand SH, the minute hand MH, and the hour hand HH.

Also, the tooth portion 81 of the gear 80 meshes with a tooth portion 101 of the adjustment wheel 100 for manually setting the minute hand MH and the hour hand HH independently of the second hand SH. A user manually turns the adjustment wheel 100 to adjust the positions of the minute hand MH and the hour hand HH. Specifically, turning the adjustment wheel 100 rotates the gear 80. Since the tooth portion 82 of the gear 80 meshes with the tooth portion 91 of the hour hand wheel 90, rotating the hour hand wheel 90 rotates the hour hand HH. Also, since the tooth portion 81 of the gear 80 meshes with the tooth portion 72 of the minute hand pipe 70, rotating the minute hand pipe 70 rotates the minute hand MH. At this time, the minute hand pipe 70 slidably rotates on the minute hand wheel 60. These arrangements will be described later in detail.

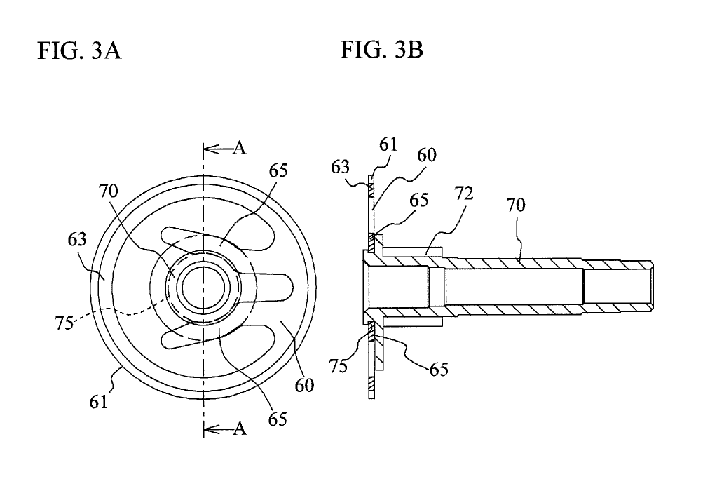

FIG. 3A is a front view of the minute hand wheel 60 and the minute hand pipe 70, and FIG. 3B is a sectional view taken along line A-A of FIG. 3A. As illustrated in FIG. 3A, the minute hand wheel 60 includes: a ring shaped portion 63 having an outer circumference formed with the tooth portion 61; and two support portions 65 extending toward the center of the minute hand wheel 60 from the ring shaped portion 63. In the minute hand pipe 70, a groove portion 75 is formed at its circumference. The two support portions 65 engage with the groove portion 75 in such a manner that the minute hand pipe 70 is sandwiched therebetween. A torque needed for rotating the minute hand wheel 60 relative to the minute hand pipe 70 is referred to as a sliding torque. The minute hand wheel 60 and the minute hand pipe 70 respectively move the minute hand MM and the hour hand HH without sliding, in a normal state. However, the minute hand wheel 60 and the minute hand pipe 70 engage with each other so as to ensure the certain degree of the sliding torque therebetween without disturbing the movement of the second hand SH at the time when the adjustment wheel 100 is manually rotated by a user.

In a case where a user does not try to rotate the adjustment wheel 100, the minute hand wheel 60 rotates according to the rotational force of the motor 20, and the minute hand pipe 70 rotates together with the minute hand wheel 60 since the minute hand pipe 70 is sandwiched between the support portions 65 of the minute hand wheel 60. Also, the hour hand wheel 90 rotates through the gear 80 in conjunction with the rotation of the minute hand pipe 70. On the other hand, when a user tries to rotate the adjustment wheel 100, a torque greater than the above mentioned sliding torque is transmitted to the minute hand pipe 70. Thus, even when the minute hand wheel 60 rotates according to the drive force of the motor 20, the rotation of the adjustment wheel 100 is transmitted to the minute hand pipe 70 and the minute hand pipe 70 slidably rotates relative to the minute hand wheel 60. The motor 20 also continues rotating during this period, whereby the second hand SH continues rotating. Thus, even when the hour hand HH and the minute hand MH are manually adjusted, the second hand SH continues rotating normally. That is, the hour hand HH and the minute hand MH can be manually adjusted independently of the second hand SH.

Next, a description will be given of the correction process of the second hand SH performed by the electronic clock C according to the present embodiment. The controller 5 corrects the position of the second hand SH by matching the output timing of the drive pulse with the rising timing of the second signal included in the standard radio wave. Also, the drive pulse output for a period from minus 0.5 seconds to plus 0.5 seconds with respect to when the second signal of the standard radio wave is received is corrected. In other words, the movement timing of the second hand SH is corrected.

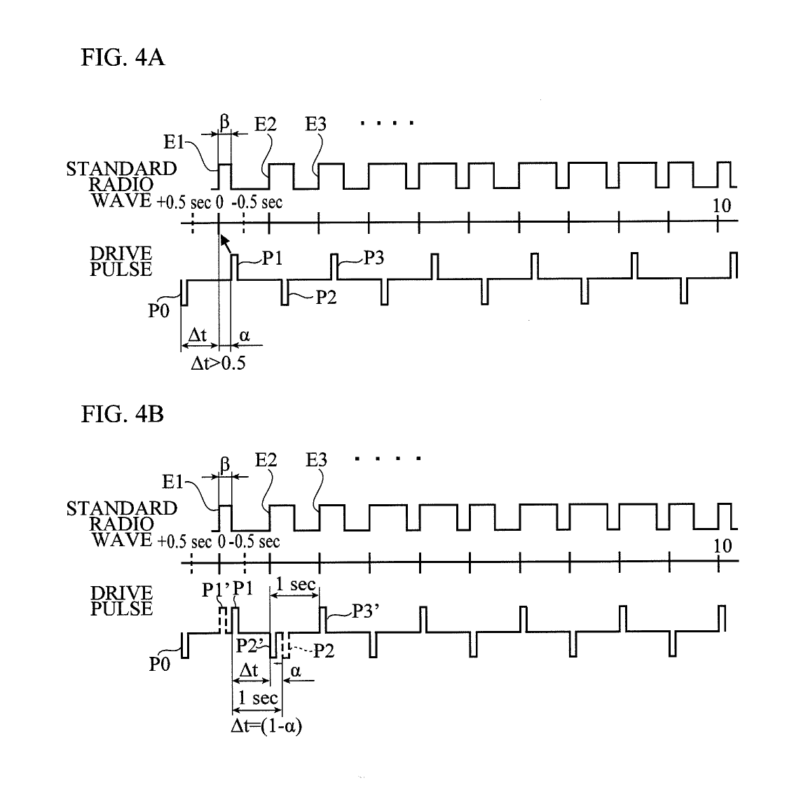

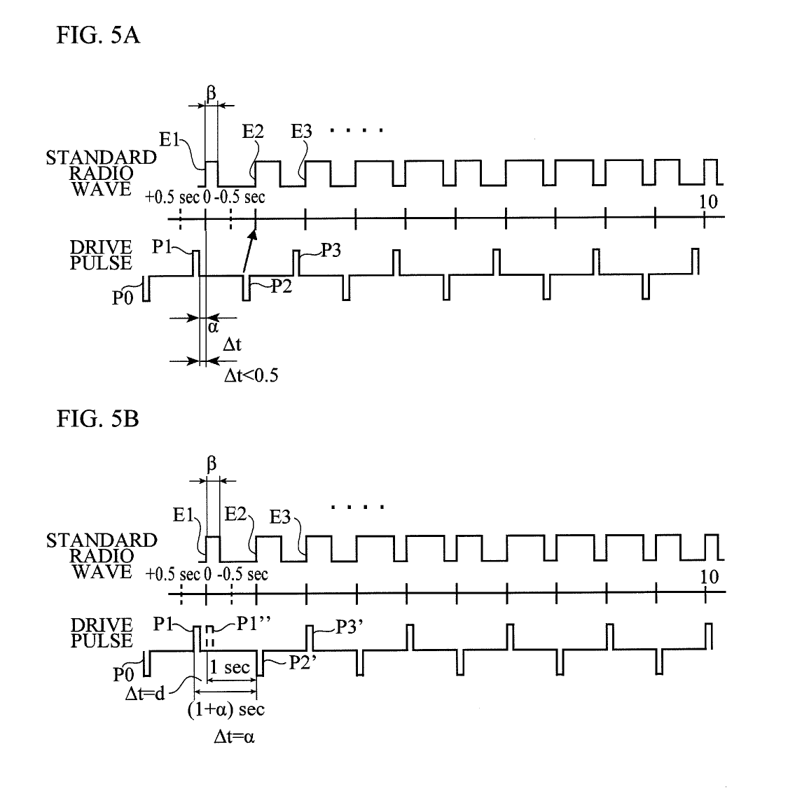

FIGS. 4A to 5B are timing charts of second signals of the standard radio waves and the drive pulses. Additionally, FIGS. 4A to 5B illustrate scales from 0 second to 10 seconds with the second signal of the standard radio wave serving as a basis, in order to facilitate understanding.

FIG. 4A is a timing chart before the drive pulses are corrected. The standard radio wave includes second signals rising every one second. FIG. 4A exemplifies a case where the drive pulses are output every one second on the basis of the drive pulse P0 and the drive pulse is output and delayed relative to the second signal of the standard radio wave by α second (0 second<α seconds<0.5 seconds). Specifically, the drive pulse P1 is output and delayed relative to the second signal E1 by α second. Likewise, the drive pulses P2 and P3 are output and delayed relative to the second signals E2 and E3 by α second, respectively.

FIG. 4B is a timing chart when the drive pulse are corrected. When the receiver 3 receives the minute-position signal E1, the controller 5 measures a period Δt, from the rising timing of the drive pulse (drive pulse P0) output just before the minute-position signal E1, to the rising timing of the minute-position signal E1. Herein, for convenience of the explanation in FIGS. 4A and 4B, it is supposed that the minute-position signal E1 is detected at the time of the falling timing thereof. For example, the controller 5 detects the pulse width (β in FIG. 4) of the second signal by a timer not illustrated. When the second signals each having a pulse width of 200 ms are continuously detected twice, the second signal detected for the second time is specified as the minute-position signal E1. The falling timing of the minute-position signal E1 is specified as the detection timing. The rising timing of the minute-position signal E1 is specified back from the detection timing.

Additionally, as mentioned above, for convenience of the explanation in FIGS. 4A and 4B, it is assumed that the minute-position signal E1 is detected at the falling timing of the minute-position signal E1. However, the present invention is not limited to this. The minute-position signal E1 may be detected, when the rising timing of the minute-position signal E1 is detected and the falling timing of the pulse E2 is detected. Also, the minute-position signal E1 may be detected, when the falling timing of the following pulse E3 is detected.

The controller 5 specifies the count-up timing of the second counter by the timer, and calculates Δt based on a difference between the rising timing of the minute-position signal E1 and the closest count-up timing of the second counter.

When the measurement result is greater than 0.5 seconds at this time, it is determined that the count-up timing of the second counter (rising of the drive pulse) is delayed relative to the rising timing of the second signal by α second. When the count-up timing of the second counter is delayed relative to the rising timing of the second signal, the controller 5 controls the second counter to count up at the time when Δt second elapses from the closest previous count-up timing of the second counter. That is, in FIG. 4B, the second counter counts up at the timing when Δt second elapses from the count up timing synchronized with the rising timing of the drive pulse P1.

The controller 5 controls a drive pulse P2′ to output synchronously with the above timing, and resets and controls the clock division circuit 2 to count up from an initial value. Hereinafter, the second counter counts up synchronously with the second signal, and drive pulses P3′ . . . are output synchronously with the second signals, respectively.

Thus, the controller 5 corrects the drive pulses and corrects the count-up timing of the second counter of the internal clock 6 to be matched with the second signal of the standard radio wave.

Therefore, it can be considered that the drive pulse P1, which is output and delayed relative to the minute-position signal E1 by α second, is corrected to the drive pulse P1′ which is output at the same time when the minute-position signal E1 is output. Additionally, the drive pulse P1′ is only a virtual signal, as a criteria of the drive pulses P2′ and P3′ output after the minute-position signal E1 is received. The drive pulse P1′ is not actually output.

Next, the process will be described when the above-mentioned Δt is smaller than 0.5. Additionally, for convenience of the explanation in FIGS. 5A and 4B, it is assumed that the minute-position signal E1 is detected at the falling timing of the minute-position signal E1. The controller 5 detects the pulse width (β in FIG. 5) of the second signal by the timer not illustrated. When the second signals each having a pulse width of 200 ms are continuously detected twice, the second signal detected for the second time is specified as the minute-position signal E1. The falling timing of the minute-position signal E1 is specified as the detection timing. The rising timing of the minute-position signal E1 is specified back from the detection timing.

FIG. 5A is a timing chart before the drive pulses are corrected. FIG. 5A exemplifies a case where the drive pulses are output every one second with the drive pulse P0 acting as a criteria and the drive pulse is output and advanced relative to the second signal of the standard radio wave by α second (0 second<α second<0.5 seconds). Specifically, the drive pulse P1 is output and advanced relative to the minute-position signal E1 by α second. Likewise, the drive pulses P2 and P3 are output and advanced relative to the second signals E2 and E3 by α second, respectively.

FIG. 5B is a timing chart when the drive pulses are corrected. When the receiver 3 receives the minute-position signal E1, the controller 5 measures a period Δt from the rising timing of the drive pulse (drive pulse P1) output last to the rising timing of the minute-position signal E1 (in this case Δt=α). When the measurement result is smaller than 0.5 seconds at this time, it is determined that the output timing of the drive pulse is advanced relative to the minute-position signal E1 only by α second, and it is decided that the hands are stopped. Thus, the controller 5 does not output the drive pulse P2 one second after the drive pulse P1 is output, but outputs the drive pulse P2′ one plus α seconds after the drive pulse P1 rises such that the drive pulse P2′ is synchronous with the rising timing of the second signal E2. Also, the drive pulses P3′ . . . are output sequentially after the drive pulse P2′ is output, as a criteria of the drive pulse P2′ every second. Therefore, it can be considered that the drive pulse P1, which is output right before the minute-position signal E1 is received, is corrected to the drive pulse P1″ which is output at the same time when the minute-position signal E1 is output. Additionally, the drive pulse P1″ is only a virtual signal, as a criteria of the drive pulses P2′ and P3′ output after the minute-position signal E1 is received. The drive pulse P1″ is not actually output. In this case, the minute-position signal E1 is output after the drive pulse P1 is output, so the output timing of the drive pulse is corrected after the minute-position signal E1 is output. Therefore, the output of the drive pulse is corrected, so the driving timing of the second hand SH is matched with the rising timing of the second signal of the standard radio wave. Additionally, in this case, the controller 5 also corrects the count-up timing of the second counter of the internal clock 6 to be matched with the second signal of the standard radio wave.

As illustrated in FIGS. 4A to 5B, the controller 5 corrects the drive pulse, which is not matched with the rising timing of the second signal of the standard radio wave within −0.5 seconds<α<0.5 seconds, to be matched with the rising timing of the second signal of the standard radio wave.

Additionally, if α is 0.5 seconds, it is determined beforehand that any one of the above processes is used, and the correction process is performed based on the determination.

Also, the controller 5 tries to receive the second signal of the standard radio wave every predetermined period. For example, the controller 5 tries to receive the second signal of the standard radio wave every three hours. This corrects the difference of the output timing of the drive pulse from the second signal of the standard radio wave so as to correct the positional displacement of the second hand SH.

For example, a clock may be used with hands set forward or back with respect to the actual time on purpose. In this case, as for a radio-controlled clock, the time is automatically corrected to match the actual time of the region where the standard radio wave is transmitted. Also, as for a normal clock except for the radio-controlled clock, a difference between the actual time and the hand-indicating time might be changed as the use time passes, due to the error of a quartz resonator.

In the electronic clock C according to the present embodiment, the minute hand MH and the hour hand HH can be corrected independently of the second hand SH. Therefore, the electronic clock C can be used in the state where the minute hand MH and the hour hand HH are set forward or back with respect to the actual time on purpose. Also, the minute hand wheel 60 and the minute hand pipe 70 engage with each other to ensure the predetermined sliding torque. Thus, the minute hand MH and the hour hand HH can be positionally adjusted at arbitrary timing without needing operation for stopping the second hand, whereby it is easy to adjust the position. Also, even if the output timing of the drive pulse is not matched with the second signal of the standard radio wave due to continued use, the receiver 3 receives the second signal of the standard radio wave, and the controller 5 corrects the output timing of the drive pulse again. Therefore, the error of the drive pulse relative to the second signal of the standard radio wave does not accumulate. Thus, even if the hands are set to the time different from the actual time, the constant difference between the actual time and the time indicated by the hands can be maintained.

Also, the electronic clock C according to the present embodiment does not correct the positions of the minute hand MH, the hour hand HH, and the second hand SH to be matched with the time information obtained from the standard time. Therefore, unlike a conventional radio-controlled clock, a mechanism is not needed for detecting the positions of the minute hand MH and the hour hand HH. Thus, in the electronic clock according to the present embodiment, the number of the parts are reduced and the cost is reduced.

Also, as mentioned above, when the minute hand MH and the hour hand HH are manually adjusted by the adjustment wheel 100, the minute hand MH and the hour hand HH can be adjusted independently of the second hand SH. Also, while the minute hand MH and hour hand HH are adjusted, the second hand SH does not stop and drives. Therefore, the positions of the minute hand MH and the hour hand HH can be adjusted while the positional accuracy of the second hand SH is maintained.

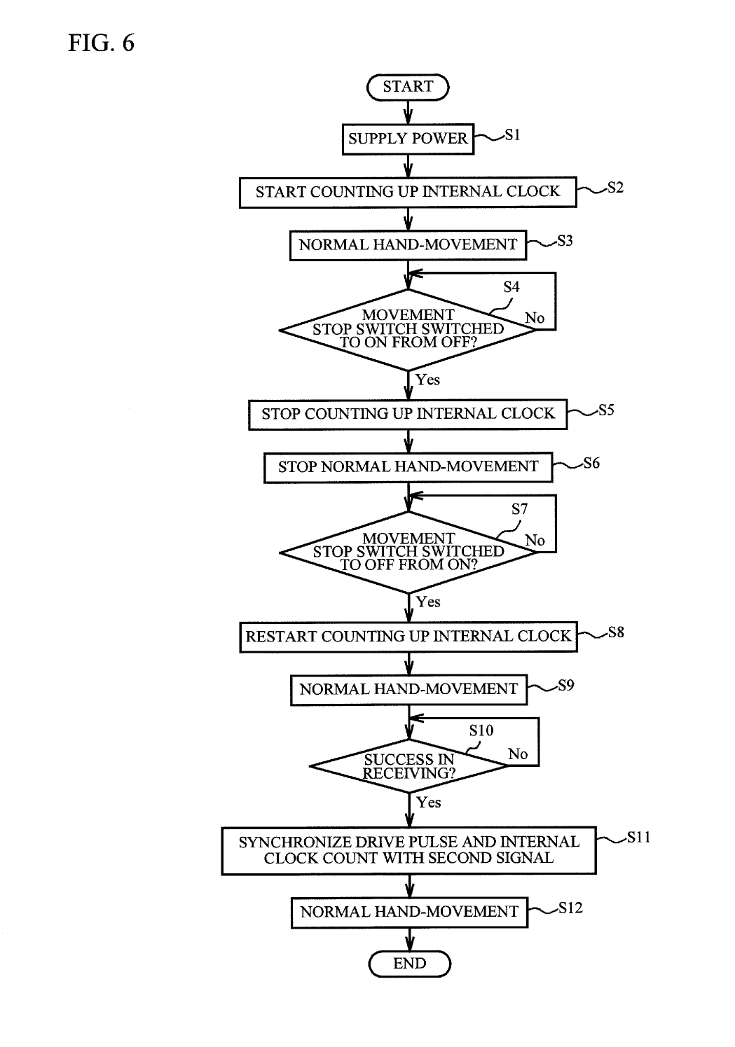

FIG. 6 is a flow chart of an example of the correction process of the second hand SH just after the power is turned on. As illustrated in FIG. 6, when the electronic clock C is turned on by installing a battery or the like (step S1), the controller 5 controls the counter of the internal clock 6 to count up (step S2) and outputs the drive pulses to the motor 20 so as to start the normal hand-movement (step S3). The controller 5 determines whether or not the movement stop switch 9 is ON. When the movement stop switch 9 is ON, the controller 5 stops moving the hands. Next, the controller 5 determines whether or not the movement stop switch 9 is switched to ON from OFF (step S4). When the movement stop switch 9 is not switched to ON from OFF, the controller 5 performs the process in step S4 again. When the movement stop switch 9 is switched to ON from OFF, the controller 5 stops the counter of the internal clock 6 (step S5), and stops outputting the drive pulse to stop moving the hands (step S6).

Next, the controller 5 determines whether or not the movement stop switch 9 is switched to OFF from ON (step S7). When the movement stop switch 9 is not switched, the controller 5 performs the process in step S7 again. When the movement stop switch 9 is switched, the controller 5 controls the counter of the internal clock 6 to restart counting-up (step S8), and restarts the normal hand-movement (step S9).

Next, the controller 5 determines whether or not to succeed in the reception of the second signal of the standard radio wave (step S10). When the negative determination is made, the process is performed in step S10 again. When the second signal of the standard radio wave is received, the controller 5 synchronizes the rising timing of the drive pulse with the rising timing of the second signal of the standard radio wave in the above manner. Also, as for the internal clock 6, the counter value of the second counter is counted up every one second by acquiring the pulse signals from the clock division circuit 2, as mentioned above. Therefore, the rising timing of the drive pulse is synchronized with the rising timing of the second signal of the standard radio wave, whereby the count-up timing of the second counter of the internal clock 6 is also synchronized with the rising timing of the second signal of the standard radio wave (step 11). The correction process of the second hand SH is performed just after the power is turned on in such a manner, thereby eliminating a difference between the rising timing of the second signal and the rising timing of the pulse signal which is detected for the period from minus 0.5 seconds to plus 0.5 seconds with respect to the second signal of the standard radio wave.

Next, the controller 5 continues the normal hand-movement of the hands (step S12). Additionally, when the reception of the standard radio wave is succeeded, the controller 5 clears the value of the counter of the internal clock 6.

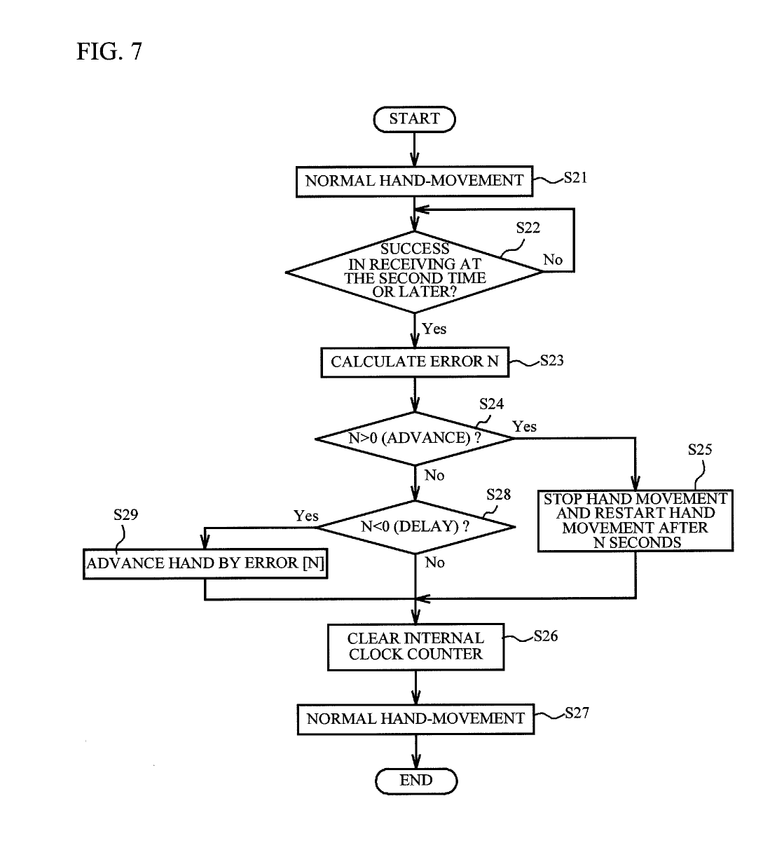

FIG. 7 is a flow chart of the correction process of the second hand SH when the standard radio wave is received at a second time or later. The controller 5 determines whether or not the reception of the standard radio wave is succeeded at the second time or later after the power is turned on (step S22), while the normal hand-movement is continued (step S21). When the negative determination is made, the process is performed in step 22 again.

When the affirmative determination is made, the controller 5 calculates a difference N between an elapsed period from when the standard radio wave is previously received to when the standard radio wave is presently received, and the measured period measured by the internal clock 6 during the elapsed period (step S23). The elapsed period can be calculated based on the time information of the standard radio wave received at the previous time and the time information of the standard radio wave received at the present time. Additionally, the time information of the standard radio wave received at the previous time is stored in a memory as mentioned above. Also, the internal counter of the internal clock 6 measures the elapsed period from when the standard radio wave is received at the previous time. Therefore, the difference, between the elapsed period measured by the internal counter of the internal clock 6 and the time information of the standard radio wave, can be calculated, on the basis of an amount of increase (measured period) in the value of the internal counter of the internal clock 6 during the elapsed period between the previous receiving time and the present receiving time with respect to the actual elapsed period. Additionally, the controller 5 stores the time information of the standard radio wave received at the present time in the memory. This is because the drive pulse is corrected in the same manner when the standard radio wave is received at the next time.

The controller 5 determines whether or not N is greater than zero (step S24). When N is greater than zero, that is, when the value of the counter of the internal clock 6 is advanced from the actual elapsed time, the controller 5 stops moving the hands and restarts moving the hands after N seconds (step S25). It is therefore possible to correct the positional displacement of the second hand SH occurring from the time when the standard radio wave is received at the previous time to the time when the standard radio wave is received at the present time. Next, the controller 5 clears the value of the internal counter of the internal clock 6 (step S26). It is thus possible to correct the error of the internal counter of the internal clock 6 occurring from the time when the standard radio wave is received at the previous time to the time when the standard radio wave is received at the present time, and it is possible to match the count-up timing of the second counter with the rising timing of the second signal. After that, the controller 5 starts the normal hand-movement again (step S27).

When the negative determination is made in step S24, the controller 5 determines whether or not N is smaller than zero (step S28). When N is smaller than zero, that is, when the counter of the internal clock 6 is delayed relative to the actual elapsed period, the controller 5 outputs the drive pulses N times to advance the second hand SH. It is therefore possible to correct the delay of the second hand SH occurring from the time when the standard radio wave is received at the previous time to the time when the standard radio wave is received at the present time. Next, the controller 5 clears the value of the internal counter of the internal clock 6 (step S26). It is thus possible to correct the error of the internal counter of the internal clock 6 caused from the time when the standard radio wave is received at the previous time to the time when the standard radio wave is received at the present time, and it is possible to match the count-up timing of the second counter with the rising timing of the second signal. After that, the controller 5 starts the normal hand-movement again (step S27).

When the negative determination is made in step S28 and the error N is zero, only the value of the internal counter of the internal clock 6 is cleared (step S26). Next, the controller 5 continues the normal hand-movement (step S27). This can prevent the error of the second hand SH from being accumulated.

Additionally, when the standard radio wave is received at the second time or later, the synchronization of the minute-position signal E1 with the drive pulse is finished by the correction process which is performed just after the power is turned on. Thus, even when a large difference, such as about ten seconds, between the minute-position signal E1 and the output timing of the drive pulse occurs, the correction process can be performed based on the internal counter of the internal clock 6. The correction process of the second hand SH can be stopped, until the error of the clock itself increases to some extent, for example, until a user feels that something is wrong. Thus, the power consumption can be suppressed.

While the exemplary embodiments of the present invention have been illustrated in detail, the present invention is not limited to the above-mentioned embodiments, and other embodiments, variations and modifications may be made without departing from the scope of the present invention.

The movement stop switch 9 may be a stopper which forcibly stops the gears by turning ON or OFF.

In the embodiment, when the standard radio wave is received at the second time or later, the correction process of the second hand SH is performed on the basis of the difference between the elapsed period measured by the internal counter of the internal clock 6 and the time information of the standard radio wave. The present invention is not limited to this. Like the correction process of the second hand SH just after the power is turned on, when the standard radio wave is received at the second time or later, the correction process may be performed to eliminate the difference between the rising timing of the latest drive pulse and the rising timing of the second signal E1 on the basis of the period Δt therebetween.

With such a configuration, the internal counter may not be provided, so the electronic clock C may be manufactured at a low cost. It is thus possible to provide the electronic clock which can maintain a difference between the actual time and the time indicated by the hands, in addition to the low cost and the low power consumption.

However, in this case, when the drive pulse matched with the second signal of the standard radio wave is not matched therewith by more than or equal to plus 0.5 seconds or less than or equal to minus 0.5 seconds due to the error of the clock itself, the drive pulse might not be matched with the second signal of the standard radio wave again, so that the positional displacement of the second hand SH might be accumulated. However, this problem can be solved by receiving the standard radio wave every predetermined time before the error of the clock itself is made by more than or equal to plus 0.5 seconds or less than or equal to minus 0.5 seconds.

Finally, several aspects of the present invention are summarized as follows.

According to an aspect of the present invention, there is provided an electronic clock including: a drive source; a second hand wheel secured with a second hand, and rotated by receiving drive force from the drive source; a connection wheel rotated by receiving a drive force from the second hand wheel; an adjustment wheel adjusting positions of a minute hand and an hour hand; a minute hand pipe secured with the minute hand, slidably connected with the connection wheel, and including a teeth portion to which drive force is transmitted from the adjustment wheel, and the minute hand pipe slidably rotating with respect to the connection wheel when the minute hand pipe receives the drive force from the adjustment wheel; an internal clock measuring an elapsed period based on a reference signal from a reference signal source; a receiver receiving a standard radio wave including time information; and a control unit outputting a drive pulse to the drive source, and performing correction process for synchronizing output timing of the drive pulse with rising timing of a pulse signal at one-second intervals of the standard radio wave.

The output timing of the drive pulse is corrected to be matched with a second signal of the standard radio wave, thereby maintaining a constant difference between the actual time and the hand-indicating time.

What is claimed is:

1. An electronic clock comprising:
a drive source;
a second hand wheel secured with a second hand, and rotated by receiving drive force from the drive source;
a connection wheel rotated by receiving a drive force from the second hand wheel;
an adjustment wheel adjusting positions of a minute hand and an hour hand;
a minute hand pipe secured with the minute hand, slidably connected with the connection wheel, and including a teeth portion to which drive force is transmitted from the adjustment wheel, and the minute hand pipe slidably rotating with respect to the connection wheel when the minute hand pipe receives the drive force from the adjustment wheel;
an internal clock measuring an elapsed period based on a reference signal from a reference signal source;
a receiver receiving a standard radio wave including time information; and
a control unit outputting a drive pulse to the drive source, and performing correction process for synchronizing output timing of the drive pulse with rising timing of a pulse signal at one-second intervals of the standard radio wave.

2. The electronic clock of claim 1, wherein the control unit controls outputting of the drive pulse based on a difference between an elapsed period, from when the receiver receives the standard radio wave at the previous time to when the receiver receives the standard radio wave at the present time, and a measured period measured by the internal clock during the elapsed period.

3. The electronic clock of claim 1, comprising a movement stop switch stopping movements of the second hand, the minute hand, and the hour hand, and stopping measurement of the internal clock.

4. The electronic clock of claim 3, wherein the control unit restarts measurement of the internal clock and restarts outputting the drive pulse so as to match count-up timing of measured time of the internal clock with the output timing of the drive pulse, when the control unit receives a signal for releasing stop of the movements from the movement stop switch.
